(19) United States
(12) Patent Application Publication
(10) Pub. No.: US 2024/0214422 A1
(43) Pub. Date: Jun. 27, 2024

(54) MACHINE LEARNING-BASED HARMFUL-WEBSITE CLASSIFICATION METHOD

(71) Applicant: DATAKOBOLD CO., LTD., Seongnam-si Gyeonggi-do (KR)

(72) Inventor: Nam Goo SONG, Suwon-si Gyeonggi-do (KR)

(73) Assignee: DATAKOBOLD CO., LTD., Seongnam-si Gyeonggi-do (KR)

(21) Appl. No.: 18/537,884

(22) Filed: Dec. 13, 2023

(30) Foreign Application Priority Data
Dec. 27, 2022 (KR) 10-2022-0185197

(51) Int. Cl. H04L 9/40; H04L 41/16

(52) U.S. Cl. CPC H04L 63/1483; H04L 41/16

(57) ABSTRACT

A machine learning-based harmful-website classification method performed by a main server includes performing tokenization, by the main server, by extracting and preprocessing an HTML source code of a website by accessing to the website, vectorizing each token according to a preset algorithm, inputting each vector value is input into a machine learning model, and determining whether the website is a harmful website.

### CROSS-REFERENCE TO RELATED APPLICATION

This application is based on and claims priority under 35 U.S.C. § 119 to Korean Patent Application No. 10-2022-0185197, filed on Dec. 27, 2022, in the Korean Intellectual Property Office, the disclosure of which is incorporated by reference herein in its entirety.

### BACKGROUND

The present disclosure relates to a machine learning-based harmful-website classification method, and more specifically, to a method and system for determining an address of an accessible harmful website among a plurality of websites accessible through the Internet based on a machine learning model.

Recently, the distribution rate of terminals capable of accessing the Internet has increased, and accordingly, teenagers and preschool children may easily access to harmful Internet pages.

In the prior art, harmful websites are classified through screenshots taken or human resources manually classify harmful websites in order to prevent such problems.

Recently, an HTML meta tag analysis method using Internet crawling has also been used instead of human resources.

However, according to the related art, harmful websites are structured to be difficult to visually distinguish from normal websites, and the websites are frequently renewed, and accordingly, there is a problem that the websites have to be responded again every time.

In addition, in the case of the HTML meta tag analysis method through crawling, the similarity measurement method using the longest common subsequence (LCS) algorithm by analyzing the tag order that accounts for the majority of the analysis method is used for new websites with different tag types. There is a problem that the detection probability is low.

### SUMMARY

The present disclosure provides a machine learning-based harmful-website classification method and a machine learning-based harmful-website classification system.

Through this, the present disclosure quickly identifies an accessible address of a harmful website activated again after a domain is changed despite ongoing crackdowns and classifies harmful websites to timely respond to a corresponding activity method, based on machine learning model.

Objects to be solved by the present disclosure are not limited to the objects described above, and other objects not described may be clearly understood from descriptions below.

According to an aspect of the present disclosure, a machine learning-based harmful-website classification method which is performed by a main server may include (a) accessing to a website, (b) performing tokenization by extracting preprocessing an HTML source code of the website, (c) vectorizing each token according to a preset algorithm, and (d) determining whether the website is a harmful website by inputting each vector value to a machine learning model, wherein the machine learning model includes a logistic regression model and predicts a probability that the website belongs to the harmful website based on output data when the output data is output as a value between 0 and 1.

Also, the machine learning model may be previously trained before (a) by using an HTML source of a harmful website and an HTML source of a normal website as training data.

Also, (a) may include (a-1) accessing a plurality of Internet websites previously stored in a database of the main server and extracting a number from a domain address of the Internet website when access fails, (a-2) determining whether the access may be made by attempting to access to the website through the domain address from which the number is extracted, and (a-3) changing a position of the number extracted from the domain address when the access fails and retrying the access to determine whether the access may be made.

Also, in (a-3), when the access fails in all cases where a position of the extracted number in a corresponding domain address is changed, a preset number may be added to or subtracted from the number, and (a-1) to (a-3) may be repeated until the access is successful.

Also, (b) may include (b-1) removing HTML tags, spaces, and special characters from HTML source codes of accessible Internet websites, (b-2) translating the HTML source codes from which the HTML tags, spaces, and special characters are removed into English and removing preset strings from the translated HTML source codes, and (b-3) classifying the HTML source codes from which the strings are removed according to a main feature and tokenizing.

Also, the main feature may include at least one of the domain name of the website, an address of an image file in the website, a link in the website, and an HTML source for a text in the website.

Also, in (c), the importance of a word may be quantified and represented as a vector by considering a frequency of words constituting the token according to a term frequency-inverse document frequency (TF-IDF) technique.

Also, in the determining whether the website is the harmful website, when a vector is input as the input data to the machine learning model, an accuracy value and F1-score may be calculated as output data, and when the calculated accuracy value and F1-score are greater than or equal to a threshold, an Internet website in which the vector is calculated may be determined as a harmful website.

Also, the accuracy value may be obtained by comparing the input data with the output data and dividing a number of pieces of correctly predicted input data by a total number of pieces of data, and the F1-Score may be obtained by calculating a number of pieces of input data of a website that is an actually harmful website and recognized as the harmful website by the machine learning model, and a number of pieces of output data of the website that is the actually harmful website and recognized as the harmful website by the machine learning model, by using a harmonic mean equation.

Also, the machine learning-based harmful-website classification method may further include storing a main feature and an HTML source code of an Internet website determined to be the harmful website in the database of the main server.

The present disclosure provides a machine learning-based harmful-website classification method and a machine learning-based harmful-website classification system and may change domain addresses or renew websites at frequent intervals, classify repetitively active harmful websites, and identify the latest accessed addresses.

Also, the present disclosure quickly provides various measures, such as blocking, sanctions, and disciplinary actions for the identified addresses, and thus, it is possible to greatly reduce the damage that users may receive by being exposed to harmful websites when visiting websites.

Also, by replacing work for classifying harmful websites previously performed by manpower, the mental fatigue experienced by workers as a result of continuous exposure to harmful contents while performing classification works may be reduced.

### BRIEF DESCRIPTION OF THE DRAWINGS

Embodiments of the inventive concept will be more clearly understood from the following detailed description taken in conjunction with the accompanying drawings in which:

FIG. 1 is a structural diagram of a harmful website classification system according to an embodiment of the present disclosure;

FIG. 2 is a block diagram illustrating an internal configuration of a main server according to an embodiment of the present disclosure;

FIG. 3 is a block diagram illustrating an internal configuration of an access unit according to an embodiment of the present disclosure;

FIG. 4 is a block diagram illustrating an internal configuration of an analysis unit according to an embodiment of the present disclosure;

FIG. 5 is a diagram illustrating main features according to an embodiment of the present disclosure;

FIG. 6 is a TF-IDF equation according to an embodiment of the present disclosure;

FIG. 7 is a flowchart illustrating of an operation of identifying an accessible address of a harmful website, according to an embodiment of the present disclosure; and

FIG. 8 is a flowchart illustrating a preprocessing operation according to an embodiment of the present disclosure.

### DETAILED DESCRIPTION OF THE EMBODIMENTS

Hereinafter, embodiments of the present disclosure will be described in detail such that those skilled in the art to which the present disclosure belongs may easily implement the present disclosure with reference to the accompanying drawings. However, the present disclosure may be implemented in many different forms and is not limited to the embodiments to be described herein. In addition, in order to clearly describe the present disclosure with reference to the drawings, portions irrelevant to the description are omitted, and similar reference numerals are attached to similar portions throughout the specification.

Throughout the present specification, when a portion is described to be “connected” to another portion, this includes not only a case where the portion is “directly connected” thereto, but also a case where the portion is “electrically connected” thereto with another element therebetween. In addition, when a certain portion is described to “include” a certain component, this means that the certain portion may further include other components without excluding other components unless otherwise stated.

In the present disclosure, a “portion” includes a unit realized by hardware, a unit realized by software, and a unit realized by using both. In addition, one unit may be realized by using two or more pieces of hardware, and two or more units may be realized by using one piece of hardware. Meanwhile, a “˜ portion” is not limited to software or hardware, and a “˜ portion” may be configured to be included in an addressable storage medium or may be configured to reproduce one or more processors. Therefore, in one example, “˜ portion” refers to components, such as software components, object-oriented software components, class components, and task components, and includes processes, functions, properties, and procedures, subroutines, segments of program code, drivers, firmware, microcode, circuits, data, databases, data structures, tables, arrays, and variables. The functions provided within the components and “portions” may be combined into a smaller number of components and “portions” or may be further separated into additional components and “portions”. Additionally, components and “portions” may be implemented to refresh one or more central processing units (CPUs) within the device.

A “terminal” to be described below may be implemented by a computer or a portable terminal capable of accessing a server or another terminal through a network. Here, the computer may include, for example, a notebook computer in which a web browser is stored, a desktop computer, a laptop computer, a virtual reality head mounted display VR HMD (for example, HTC VIVE, Oculus Rift, GearVR, DayDream, PSVR, and so on), and so on. Here, the VR HMD includes a VR HMD for a personal computer (PC) (for example, HTC VIVE, Oculus Rift, FOVE, Deepon, or so on) and VR HMD for mobile terminal (for example, GearVR, DayDream, Stormtrooper, Google Cardboard, or so on), a standalone model that are independently implemented of VR HMD for console (PSVR) (for example, Deepon, PICO, or so on), and so on The portable terminal is, for example, a wireless communication device that ensures portability and mobility, and includes not only a smartphone, a tablet PC, and a wearable device, but also various devices equipped with communication modules, such as a Bluetooth (Bluetooth low energy (BLE)) module, a near field communication (NFC) module, a radio frequency identification (RFID) module, and an ultrasonic module, an infrared module, a Wi-Fi module, and a LiFi module. In addition, the “network” refers to a connection structure capable of exchanging information between nodes, such as a terminal and a server and includes a local area network (LAN), a wide area network (WAN), the Internet (WWW: World Wide Web), a wired and wireless data communications network, a telephone network, a wired and wireless television communication network, and so on. For example, the wireless data communication network includes third generation (3G), fourth generation (4G), fifth generation (5G), third generation partnership project (3GPP), long term evolution (LTE), world interoperability for microwave access (WIMAX), Wi-Fi, Bluetooth communication, infrared communication, ultrasonic communication, visible light communication (VLC), LiFi, and so on but are not limited thereto.

The present disclosure provides a machine learning-based harmful-website classification method and a machine learning-based machine learning-based harmful-website classification system which quickly identify an accessible address of a harmful website activated again after a domain is changed and classify harmful websites to timely respond to a corresponding activity method, based on a machine learning model.

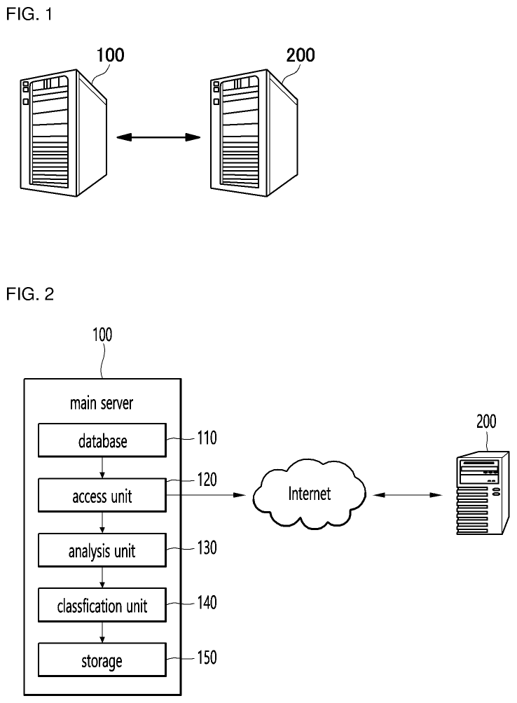

Referring to FIG. 1, a machine learning-based harmful website classification system according to an embodiment of the present disclosure may include a main server 100 and a harmful website server 200.

The main server 100 may be connected to the Internet through a communication network to access various harmful websites provided by the harmful website server 200, and to this end, the main server 100 may be connected to the communication network wired or wirelessly to perform communication therewith.

Also, referring to FIG. 2, the main server 100 according to the embodiment of the present disclosure may include a memory storing a program (or an application) that performs a machine learning-based harmful websites classification method, a processor that executes the program, and a plurality of devices, and a database 110 that stores data necessary for accessing multiple harmful websites.

Here, the processor may perform various functions according to execution of the program stored in the memory, and according to each function, the detailed components included in the processor may include an access unit 120, an analysis unit 130, and a classification unit 140, and a storage 150.

Detailed descriptions of the components described above are made below along with a description of a machine learning-based harmful-website classification method according to an embodiment of the present disclosure.

In addition, the harmful website server 200 may be connected to the Internet through a communication network to provide various harmful websites, and go through a domain name system (DNS) server to support access to harmful websites.

Here, the DNS server provides a service that allows a user to go to a desired website even when the user inputs a domain name, such as example.com when the user opens a web browser and goes to a website, instead of communicating through an Internet protocol (IP) address of all computers, on the Internet, including user terminals, such as smartphones or laptops, and servers that provide websites or web content, and controls which server a user terminal is connect to by converting a human-readable name, such as www.example.com, into a numeric IP address, such as 192.0.2.1.

Because the DNS server corresponds to the known art, detailed descriptions thereof are omitted in the present disclosure.

Hereinafter, a machine learning-based harmful-website classification method performed by the main server 100, according to an embodiment of the present disclosure, is described.

First, the main server 100 accesses to a harmful website provided by the harmful website server 200.

In this case, data, such as an IP address and a domain address required for initial access to the harmful website may be stored in advance in the database 110 of the main server 100.

To this end, the main server 100 attempts to access a plurality of Internet websites previously stored in the database 110, that is, a harmful website, and extracts a number from the domain address of a corresponding Internet website.

This is to deal with the use of a method for changing a number at every renewal by renewing a website at preset intervals to avoid punishment, such as blocking or disciplinary action, against the majority of recently operated harmful websites and by including a certain number in the domain address for accessing the website.

To this end, the main server 100 according to the embodiment of the present disclosure attempts to access the website through the domain address from which the number is extracted and determines whether access may be made.

When the access through the address fails, the main server 100 changes a position of the number extracted from the domain address within the address, retries the access, and determines whether the access may be made.

For example, it is assumed that the main server 100 attempts to access to a domain address, such as www.example1.com, and the access to that address fails.

In this case, the main server 100 extracts a number 1 from the address of www.example1.com, changes a position of the extracted number, and attempts access thereto again.

The change in number may consist of an example, such as www.example.com or www.example.com, and according to another embodiment of the present disclosure, a position in which the number may be changed within the domain address is a grammatical part of the domain address, such as world wide web (www), and a company (com), a network (net), and a period (.) may be excluded, and only a space between strings, such as an example, that corresponds to a characteristic part of the domain address may be a target.

In addition, when the main server 100 fails to access in all cases of changing a position in an address of the number extracted from a corresponding domain address, the main server 100 may add a preset number to or subtract the preset number from the number and repeat until the access is successful.

For example, as in the example described above, it is assumed that the main server 100 attempts to access to a domain address, such as www.example1.com, and the access fails in all cases where the number 1 is changed in the domain address.

In this case, the main server 100 may retry access to www.example2.com and www.example0.com which are addresses obtained by adding a preset number (for example, 1) to or subtracting the preset number (for example, 1) from the number 1 of the known address of www.example1.com.

Also, an access attempt, which changes a position within a domain address by extracting numbers 0 and 2 of an address of the changed number, may be subsequently performed.

The access attempt process may be performed by the access unit 120 of the main server 100 according to the embodiment of the present disclosure.

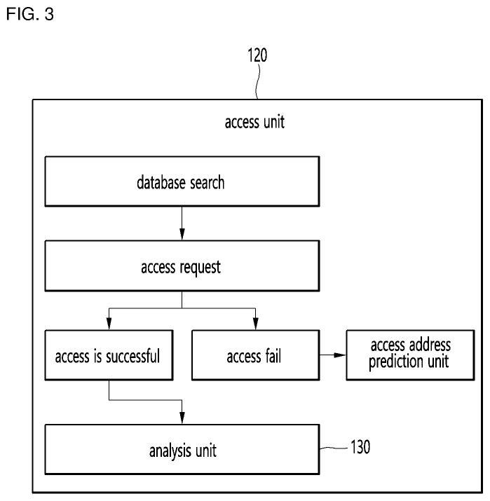

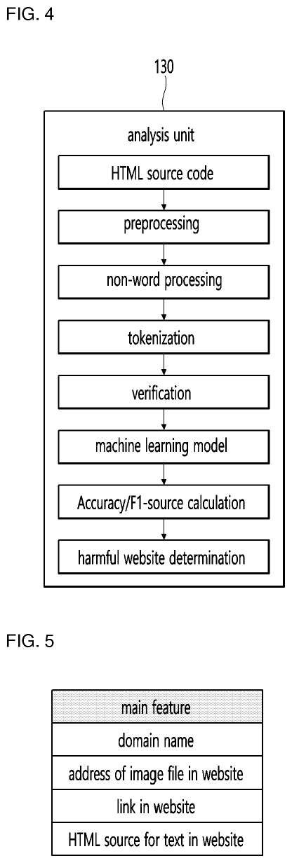

Referring to FIG. 3, the access unit 120 according to an embodiment of the present disclosure may search the database 110 for domain addresses of a plurality of websites to be attempted to access and attempt access by generating an access request as described above.

In this case, when the access is successful, the domain address of a corresponding website may be transmitted to the analysis unit 130, and when the access fails, the domain address to which the access fails may be transmitted to an access address prediction unit.

According to one embodiment of the present disclosure, the access address prediction unit changes a position and size of a number in the domain address where access fails in the manner described above.

Next, the main server 100 extracts HTML source codes of a website, performs preprocessing of the HTML source codes, and performs tokenization.

According to an embodiment of the present disclosure, the HTML source codes are texts that represent a language operating in a web browser to provide an Internet web page and may be provided from a server which provides the Internet web page or extracted through crawling or so on.

The HTML source code includes an HTML tag, and a space and special character used in the grammar required for coding.

The main server 100 performs a preprocessing process of removing HTML tags, spaces, and special characters from the HTML source codes of an accessible Internet website, translating the HTML source codes including the removed tags, spaces, and special characters into English, and removing preset strings from the translated HTML source codes.

The classification unit 140 of the main server 100 classifies the preprocessed HTML source codes according to main features and tokenizes the classified HTML source codes.

In the present disclosure, tokenization is to divide corresponding data into individual tokens according to the intended use, which corresponds to the known art, and is not described in detail in the present disclosure.

Referring to FIG. 5, a main feature according to an embodiment of the present disclosure includes at least one of a domain name of a website, an address of an image file in the website, a link included in the website, and an HTML source for a text in the website, and the main server 100 tokenizes the HTML source code for each major feature described above.

Next, according to a term frequency-inverse document frequency (TF-IDF) technique, the main server 100 quantifies the importance of a corresponding word by considering the frequency of word constituting each token, and represents the quantified importance as a vector, thereby vectorizing each token.

According to an embodiment of the present disclosure, the main server 100 gives a high weight to a word that frequently appear in each token according to the TF-IDF technique, and assigns a vector value to a document included in a corresponding token such that a penalty and a weight are given to a word that appears frequently.

In this case, by giving a penalty to a word that appears frequently in all documents included in the token and giving a high weight to a word that appears frequently in only a corresponding document, the word that received the penalty or weight may be checked to see whether the word is actually an important word.

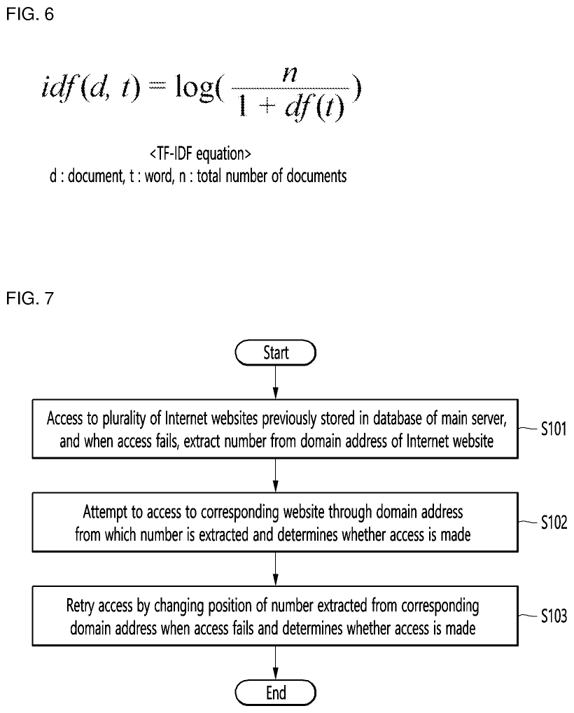

To this end, a TF-IDF equation illustrated in FIG. 6 may be used.

Referring to FIG. 6, the main server 100 may count how many times a certain word appears in the document included in a certain token by using the total number of documents, words, and documents as variables as represented by the equation.

In this case, n in the equation is a fixed value, and accordingly, as df(t) increases, log(n/df(t)) decreases. Here, df(t) refers to the number of documents including a certain word t, and accordingly, a large number of documents including the certain word t means that t is a commonly used word, which means that t is not a substantially important word. Therefore, a value of log(n/df(t)) is reduced, and a penalty may be given thereto.

Next, the main server 100 according to the embodiment of the present disclosure may determine whether a website is a harmful website by using vector values extracted by various methods, and according to a preferred embodiment, a machine learning models may be used.

In the present embodiment, the machine learning model includes a logistic regression model, and when output data is output as a value between 0 and 1, the probability that a website belongs to a harmful website may be predicted based on the output data.

In this case, the machine learning model is a supervised learning method that uses an HTML source of a harmful website and an HTML source of a normal sits as training data, and may be trained in advance before the main server 100 accesses a certain website.

The machine learning model according to an embodiment of the present disclosure may calculate an accuracy value and F1-score as output data when a vector is input as input data to the machine learning model, and may determine that the Internet website from which the vector is calculated is a harmful website when the calculated accuracy value and F1-score are greater than or equal to a threshold.

In this case, the accuracy value may be obtained by comparing the input data with the output data and by dividing the number of pieces of correctly predicted input data by the total number of pieces of data, and F1-Score may be obtained by calculating the number of pieces of input data of a website that is an actually harmful website and recognized as a harmful website by a machine learning model, and the number of pieces of output data of the website that is an actually harmful website and recognized as the harmful website by the machine learning model, by using a harmonic mean equation.

Therefore, the main server 100 according to the embodiment of the present disclosure may determine how accurately the machine learning model determines a harmful server based on the accuracy value and F1-score.

The storage 150 of the main server 100 stores the main feature and HTML source code of the Internet website determined to be a harmful website through the above-described process in the database 110 of the main server 100.

According to another embodiment of the present disclosure, when accessing a certain website in the database 110 to classify a harmful website, the main server 100 may access to the database 110 where the main feature and the HTML source code of the harmful website are stored with a lower priority than a website that is not classified as a harmful website or a website that classification is not performed.

Therefore, the main server 100 may verify a larger number of websites that are not classified as harmful websites or that classification is not performed by attempting later an access to the website that is already classified as a harmful website.

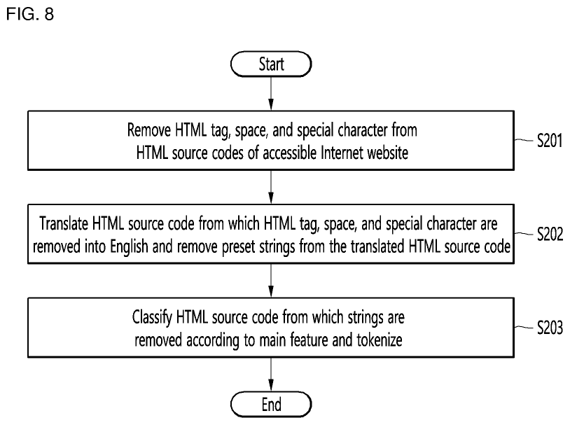

Hereinafter, a process of identifying an accessible address of a harmful website and a preprocessing process according to an embodiment of the present disclosure are described again with reference to FIGS. 7 and 8.

Referring to FIG. 7, in the process of identifying an accessible address of a harmful website according to an embodiment of the present disclosure, first, the main server 100 accesses to a plurality of Internet websites previously stored in the database 110, and when the access fails, the server 100 extracts a number from a domain address of one of the plurality of Internet websites (S101).

Subsequently, the main server 100 attempts to access to a corresponding website through the domain address from which the number is extracted and determines whether access may be made (S102).

Thereafter, when the access fails, the main server 100 retry the access by changing a position of the number extracted from the corresponding domain address and determines whether the access may be made (S103).

Subsequently, referring to FIG. 8, in the preprocessing process according to an embodiment of the present disclosure, HTML tags, spaces, and special characters are first removed from HTML source codes of accessible Internet websites (S201), the HTML source codes from which the HTML tags, spaces, and special characters are removed are translated into English and preset strings are removed from the translated HTML source codes (S202), and the HTML source codes from which the strings are removed are classified according to a main feature and tokenized (S203).

One embodiment of the present disclosure may be implemented in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium and a communication medium. A computer storage medium includes both volatile and nonvolatile media and removable and non-removable media implemented by any method or technology for storing information, such as computer readable instructions, data structures, program modules or other data.

Although the method and systems of the present disclosure are described with reference to specific embodiments, some or all of their components or operations may be implemented by using a computer system having a general-purpose hardware architecture.

The above description of the present disclosure is for illustrative purposes, and those skilled in the art to which the present disclosure belongs will understand that the present disclosure may be easily modified into another specific form without changing the technical idea or essential features of the present disclosure. Therefore, the embodiments described above should be understood as illustrative in all respects and not limiting. For example, each component described as a single type may be implemented in a distributed manner, and likewise, components described as distributed may be implemented in a combined form.

The scope of the present disclosure is indicated by the following claims rather than the detailed description above, and the meaning and scope of the claims and all changes or modifications derived from the equivalent concepts should be interpreted as being included in the scope of the present disclosure.

What is claimed is:

1. A machine learning-based harmful-website classification method which is performed by a main server, the machine learning-based harmful-website classification method comprising:
Extracting numbers from domain addresses of a plurality of Internet websites previously stored in a database of the main server, attempting to access a website corresponding to a domain address from which the number is extracted, repeating the attempt to access by changing a position of the extracted number in the domain address until the access is successful when the access fails, adding a preset number to or subtracting the preset number from the number when the access fails in all cases of changing, in the domain address, the position of the extracted number between all strings excluding a grammar part of the domain address, and accessing to a certain website by repeating the attempt to access until the access is successful;
Performing preprocessing of removing an HTML tag, a space, and a special character from an HTML source code of the website, translating the HTML source code in which the HTML tag, space, and special character are removed into English, and removing a preset string from the HTML source code and performing tokenization;
Vectorizing each token by classifying the preprocessed HTML source code according to a main feature including a domain name of the website, an address of an image file in the website, a link in the website, and an HTML source for a text in the website according to a preset algorithm; and
Determining whether the website is a harmful website by inputting each token and a vector value assigned to each token to a machine learning model previously trained by using the vector value, an HTML source of a harmful website, and an HTML source of a normal website as training data according to a supervised learning method, before the vectorizing of each token,
wherein the machine learning model includes a logistic regression model and predicts a probability that the website belongs to the harmful website based on output data when the output data is output as a value between 0 and 1.

2. The machine learning-based harmful-website classification method of claim 1, wherein, in the determining whether the website is the harmful website,
when a vector is input as input data to the machine learning model, an accuracy value and F1-score are calculated as output data, and when the calculated accuracy value and F1-score are greater than or equal to a threshold, an Internet website in which the vector is calculated is determined as a harmful website.

3. The machine learning-based harmful-website classification method of claim 2, wherein
the accuracy value is obtained by comparing the input data with the output data and dividing a number of pieces of correctly predicted input data by a total number of pieces of data, and
the F1-Score is obtained by calculating a number of pieces of input data of a website that is an actually harmful website and recognized as the harmful website by the machine learning model, and a number of pieces of output data of the website that is the actually harmful website and recognized as the harmful website by the machine learning model, by using a harmonic mean equation.

4. The machine learning-based harmful-website classification method of claim 1, further comprising:
storing a main feature and an HTML source code of an Internet website determined to be the harmful website in the database of the main server.
